(19) United States
(12) Patent Application Publication
(10) Pub. No.: US 2010/0029228 A1
(43) Pub. Date: Feb. 4, 2010

(54) EDGE POWER RAMP USING LOGARITHMIC RESISTOR ATTENUATOR

(76) Inventors: Alan Holden, McKinney, TX (US); Hamid Safiri, Plano, TX (US); Michel J.G.J.P. Frechette, Plano, TX (US); Sherif H.K. Embabi, Plano, TX (US); Abdellatif Bellaouar, Richardson, TX (US); Stephen Arnold Devison, Waterloo (CA); Tajinder Manku, Waterloo (CA)

Correspondence Address: EATON PEABODY PATENT GROUP, LLC, P.O. BOX 5249, 77 Sewall Street, Suite 3000, AUGUSTA, ME, 04332-5249, US

(21) Appl. No.: 12/520,518

(22) PCT Filed: Dec. 20, 2007
(86) PCT No.: PCT/CA2007/002318

§ 371 Date: Jun. 19, 2009

Related U.S. Application Data
(60) Provisional application No. 60/871,312, filed on Dec. 21, 2006.

(51) Int. Cl. H04B 1/04

(52) U.S. Cl. 455/127.1

(57) ABSTRACT

A power ramping circuit for use in the transmit path of a radio frequency (RF) circuit. The power ramping circuit includes parallel connected transistors used as logarithmic resistor attenuators for adjusting current to a mixer circuit in the transmit path. The parallel connected transistors can be sized differently, and are sequentially turned off to gradually increase the current provided to the mixer circuit. A ramp control circuit controls the parallel connected transistors in response to either an analog signal or a digital signal.

### CROSS REFERENCE TO RELATED APPLICATIONS

This application claims the benefit of priority of U.S. Provisional Patent Application No. 60/871,312 filed on Dec. 21, 2006, the contents of which are incorporated herein by reference in their entirety.

### FIELD OF THE INVENTION

The present invention relates generally to power control in radio frequency (RF) circuits. More particularly, the present invention relates to power ramping in RF circuits for use in wireless transceivers.

### BACKGROUND OF THE INVENTION

The evolution of wireless systems includes the Enhanced Data Rates for Global Evolution (EDGE) standard. The EDGE standard is an extension of the Global System for Mobile Communications (GSM) standard and is a digital mobile phone technology that allows increased data transmission rates and improved data transmission reliability. EDGE networks can be used for any packet switched application including Internet connections. High-speed data applications such as video services and other multimedia benefit from increased data capacity. However, the rollout of new generation wireless systems presents unique challenges to mobile handset designers. In order to benefit fully from the expanded capacity and data bandwidth of new technology such as EDGE, new handsets must work on both the new systems as well as the old.

As mobile phone architectures have evolved, their power consumption and cost have decreased while their efficiency and performance have increased. Meanwhile, the wireless base stations that serve these phones have strived to keep up with these improvements. Over half of a modern base station's power consumption is associated with the power amplifier, so continuous system-level efforts are being made to improve its energy efficiency. The time division multiple access (TDMA) architectures found in GSM and EDGE systems must be capable of ramping their power envelopes up and down within prescribed limits of power versus time. If critical ramp timing is not optimally managed, information can be lost on the transmit slot or interference can be caused by transmission during the receive slot.

Networks including EDGE technology increases the data rate over that available with GSM by sending more bits per RF burst. More bits are sent in EDGE by using a modulation scheme based on 8-phase shift keying (8-PSK). This provides an increase over GSM's Gaussian minimum shift keying (GMSK) modulation format. In the EDGE modulation scheme, the 8-PSK constellation is rotated to avoid the problems associated with zero crossings. In contrast to GMSK's constant amplitude envelope, the added rotation factor in the EDGE modulation scheme results in a non-constant amplitude envelope. This non-constant amplitude envelope presents some difficulties with regard to RF power control. These problems are exacerbated by the desire to have one transmitter that can be used for both the GSM and EDGE standards. The EDGE system standard requires that a power amplifier ramp up and down with the same speed as for GSM. Thus, the loop must have a response fast enough to provide an adequate rise time, and slow enough to avoid ringing or instability.

Known techniques for power ramping include providing a high-speed current-output digital to analog converter (DAC) that can be used with a single op amp to generate a ramp profile that fits the RF gain requirements. The ramp is applied to the voltage control pin of a variable-gain amplifier (VGA) to control the gain of the RF signal. Specifying the offset, rise time, fall time, amplitude profile, and period information allows the DAC to curve fit the desired ramp. This profile information can be stored in microprocessor control logic. However, this solution can be costly to implement.

It is, therefore, desirable to provide cost effective power ramping in RF circuits for transmitting signals used in wireless applications.

### SUMMARY OF THE INVENTION

It is an object of the present invention to obviate or mitigate at least one disadvantage of previous power ramping techniques in RF circuits for transmitting signals used in wireless applications including mobile handset terminals.

In a first aspect, the present invention provides a transmit circuit for a wireless transceiver. The transmit circuit including an antenna for wirelessly transmitting a data signal, a mixer, and a power ramping circuit. The mixer is coupled to the antenna for providing the data signal in response to a preconditioned data signal. The power ramping circuit has an input transistor for providing the preconditioned data signal in response to an input data signal. The power ramping circuit has a controllable resistance means for ramping the input data signal from a minimum voltage level to a maximum voltage level by decreasing a resistance of the resistance means. In one embodiment of the present aspect, the power ramping circuit includes a voltage to current converter and a current mirror circuit. The voltage to current converter provides a current corresponding to a base-band signal. The current mirror circuit has an input terminal for receiving the current and the input transistor has an output terminal for providing the preconditioned data signal. The controllable resistance means is coupled between the input transistor gate terminal and a voltage supply. The current mirror circuit includes a filter connected in parallel to the controllable resistance means, where the filter is a first order filter including a resistor and a capacitor such that the resistor and the controllable resistance means form a voltage divider.

In another embodiment of the present aspect, the controllable resistance means includes a plurality of parallel connected transistors. The plurality of parallel connected transistors each include a gate terminal coupled to a ramp control circuit. The ramp control circuit sequentially turns off each one of said plurality of parallel connected transistors, for ramping the input data signal from the minimum voltage level to the maximum voltage level. The ramp control circuit includes an analog to digital (A/D) converter and a digital decoder. The A/D converter provides a digital output corresponding to an analog control signal. The digital decoder selectively turns off each one of said plurality of parallel connected transistors in response to the digital output from the A/D converter. Alternately, the ramp control circuit includes a counter and a digital decoder. The counter provides a digital output corresponding to counted edges of an oscillating signal. The digital decoder selectively turns off each one of said plurality of parallel connected transistors in response to the digital output from the counter. In another alternate embodiment, the plurality of parallel connected transistors each include a gate terminal coupled to a ramp control circuit, where the ramp control circuit includes a voltage divider circuit connected between a voltage supply and an analog control signal. The voltage divider circuit has voltage taps each coupled to each one of the plurality of parallel connected transistors.

In a second aspect, the present invention provides a power ramping circuit for a wireless transmit circuit. The power ramping circuit includes a voltage to current converter, a current mirror, and a plurality of controlled resistance elements. The voltage to current converter provides an input current corresponding to a base-band voltage signal. The current mirror provides a data signal having a current with a maximum magnitude corresponding to the input current. The plurality of controlled resistance elements are coupled in parallel to the current mirror for ramping the current of the data signal from a minimum magnitude to the maximum magnitude as each of the controlled resistance elements are turned off. In an embodiment of the present aspect, the current mirror includes a diode connected transistor and an input transistor. The diode connected transistor is coupled between the voltage to current converter and a voltage supply for receiving the input current. The input transistor is arranged in a current mirror configuration with the diode connected transistor. The input transistor has a drain terminal for providing the data signal, and a source terminal coupled to the voltage supply. The plurality of controlled resistance elements are coupled between the voltage supply and a gate terminal of the input transistor. The current mirror can include a first order filter having a resistor connected between the gate terminal of the input transistor and the diode connected transistor, and a capacitor coupled between the gate terminal of the input transistor and the voltage supply.

According to another embodiment of the present aspect, the plurality of controlled resistance elements include a plurality of parallel connected transistors, where all of the plurality of parallel connected transistors are sized differently from each other. More particularly, each of the plurality of parallel connected transistors are sized to have different W/L dimensions, where W is a width and L is a length of each of the plurality of parallel connected transistors, which can be turned off in order of increasing size. In an aspect of the present embodiment, the plurality of parallel connected transistors each include a gate terminal coupled to a corresponding gate control signal of a ramp control circuit, for sequentially turning off each one of said plurality of parallel connected transistors. The ramp control circuit can include an analog to digital (A/D) converter and a digital decoder. The A/D converter provides a digital output corresponding to an analog control signal. The digital decoder selectively turns off each one of said plurality of parallel connected transistors in response to the digital output from the A/D converter. Alternately, the ramp control circuit can include a counter and a digital decoder. The counter provides a digital output corresponding to counted edges of an oscillating signal. The digital decoder selectively turns off each one of said plurality of parallel connected transistors in response to the digital output from the counter.

In a third aspect, the present invention provides a method of ramping a signal within a wireless transceiver. The method includes applying a voltage corresponding to a base band signal to an input transistor; discharging the voltage with parallel connected transistors to minimize a current corresponding to the base band signal; and sequentially turning off each of the parallel connected transistors for increasing a magnitude of the current provided by the input transistor. The step of discharging includes turning on all of the parallel connected transistors. In an aspect of the current embodiment, the step of sequentially turning off includes receiving an analog ramp control signal; and turning off at least two of the parallel connected transistors at different rates and at substantially the same time in response to the ramp control signal.

According to an embodiment of the present aspect, the step of sequentially turning off includes receiving a ramp control signal; converting the ramp control signal into a digital output; and decoding the digital output to turn off at least one of the parallel connected transistors. In an aspect of the present embodiment, the ramp control signal is a ramped analog voltage level and the step of converting includes executing analog to digital conversion to provide the digital output corresponding to the analog voltage level at a predetermined frequency. Alternately, the ramp control signal is an oscillating clock signal and the step of converting includes counting active edges of the oscillating clock signal with a counter to provide the digital output corresponding a value of the counter.

In a first aspect, the present invention provides a transmit path for a wireless transceiver, the transmit path including: an input for receiving a signal to be transmitted from an antenna via a mixer, variable gain amplifier, and power amplifier; a power ramping circuit coupled between the input and the mixer for applying a linear ramping profile to the signal so as to form a ramped signal, the power ramping circuit including a voltage to current (V2I) converter having an output coupled to a filter, a plurality of transistors coupled in parallel to the filter, an input transistor driven by the plurality of transistors; and wherein the input transistor feeds the ramped signal to the mixer.

In a further embodiment, there is provided a power ramping circuit for a wireless transceiver, the power ramping circuit including: an input for receiving a signal to be transmitted from an antenna; a voltage to current (V2I) converter having an output coupled to a filter; a plurality of transistors coupled in parallel to the filter; and an input transistor driven by the plurality of transistors; wherein the power ramping circuit applies a linear ramping profile to the signal so as to form a ramped signal, and the input transistor feeds the ramped signal to a mixer.

In further aspect, the present invention provides a method of ramping a signal within a wireless transceiver, the method including: receiving a signal to be transmitted from an antenna; converting a voltage corresponding to the signal to a current; filtering the current; and increasing the current to form a ramped signal in accordance with a linear ramping profile by way of a plurality of transistors connected in parallel with the filter.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a block diagram of a transmit path circuit in accordance with the present invention.

FIG. 2 is a graphical depiction of the ramping function of the present invention.

FIG. 3 is a circuit diagram of the ramping circuit in accordance with the present invention.

FIG. 4 is a block diagram of ramp control elements using an analog control voltage in accordance with the present invention.

FIG. 5 is a block diagram of ramp control elements using a digital control voltage in accordance with the present invention

FIG. 6 is a plot of ramp transistor gate voltages versus an analog ramp control voltage; and,

FIG. 7 is a circuit schematic of a ramp control circuit for generating analog ramp control voltages.

### DETAILED DESCRIPTION

Generally, the present invention provides a method and apparatus for power ramping in an RF transmit circuit. Such a transmit circuit of a wireless transceiver for transmitting signals may be used in mobile handset terminals for wireless applications. In particular, the present invention includes a logarithmic resistor attenuator for power ramping.

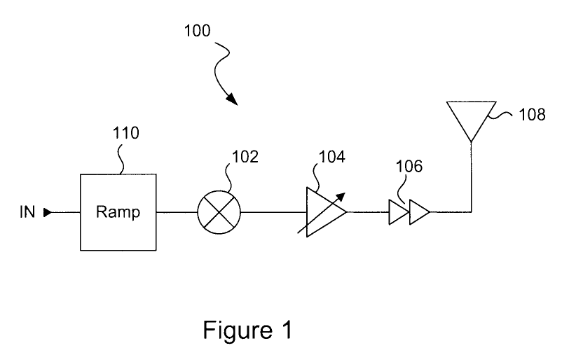

With reference to FIG. 1, there is shown a generalized block diagram of transmit path circuits in accordance with the present invention. Typically, the transmit path is designed to provide the required level of performance at the worst-case output power level. The transmit signal path 100 includes several elements known to one of ordinary skill in the art of RF circuitry to be standard RF transmit components. Such elements include a mixer 102, a variable gain amplifier (VGA) 104, a power amplifier 106, and an antenna 108. Such specific transmitter design may advantageously employ the power ramping techniques described herein. However, it should be understood that various modifications may be made to the particular arrangement shown in FIG. 1. For example, fewer or additional filters, buffers, and amplifier stages may be provided in the transmit signal path 100. Moreover, the elements within the transmit signal path 100 may be arranged in different configurations. Further, variable gain in the transmit signal path 100 may be provided by a VGA as shown, or alternatively by variable attenuators, multipliers, other variable gain elements, or a combination thereof. In alternative transmitter designs, a direct upconversion architecture may be used where the power amplifier receives a modulated RF signal directly. In general, the power ramping techniques described herein may be used for a transmit path regardless of how the modulated RF signal is generated.

Generally, the transmit circuit of the transmit signal path 100 receives a data signal “IN” and up-converts such signal to a carrier frequency via mixer 102. The signal gain is then adjusted by VGA 104 and then output through power amplifier 106 prior to carrier transmission as a data signal via antenna 108. As mixer 102, VGA 104, power amplifier 106, and antenna 108 and their functions are well known to those skilled in the RF circuitry art, they will not be further specifically detailed. Within the present invention however, the necessary rate of power increase of the signal “IN” is provided to the mixer 102 in an inventive manner.

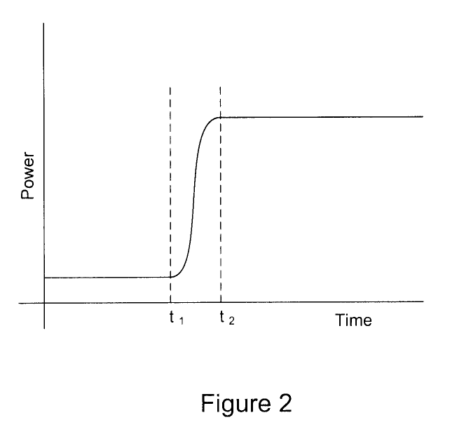

According to an embodiment of the present invention, power ramping of a base band signal “IN” is controlled by a power ramping circuit 110 as seen in FIG. 1. The power ramping circuit 110 controls the rate of power increase of the signal thus provided to the input of the mixer 102. As shown in FIG. 2, the function of power ramping circuit 110 is illustrated. From the graph it can be seen that power is minimal prior to time t₁ and at time t₂ ramps up to maximum power at which time a signal is to be transmitted. Thus, the power ramping circuit 110 will gradually and linearly increase the power until time t₂ when the maximum power is attained.

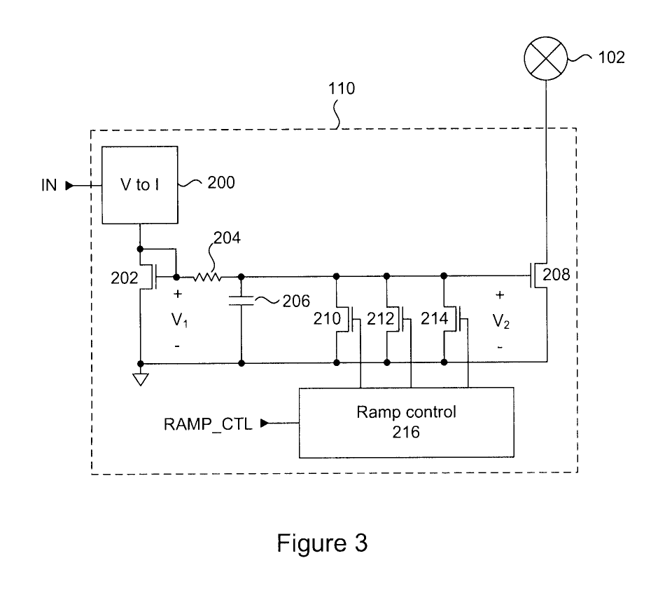

FIG. 3 is a circuit embodiment of the power ramping circuit 110 which can be considered a pre-amplifier circuit for providing a preconditioned data signal to the mixer 102. The power ramping circuit 110 includes a voltage to current (V-I) converter 200 for converting the input signal “IN” to a current. This current is passed through a first order filter formed by a diode connected n-channel transistor 202 with resistor 204 and capacitor 206 elements. An input transistor 208 is connected to the other end of the resistor, which is connected to an input of the mixer 102 of FIG. 1. The gate of input transistor 208 receives an input data signal corresponding to the current provided by V-I converter 200, which itself corresponds to input signal “IN”. The n-channel transistor 202 and the input transistor 208 are arranged in a current mirror configuration where transistor 202 has an input terminal for receiving a current corresponding to “IN” and transistor 208 has an output terminal for providing an output current. Therefore the current through n-channel transistor 202 will be mirrored in input transistor 208, provided that n-channel transistor 202, input transistor 208 are identically sized and the voltage on their gates is unchanged. However, connected in parallel with the capacitor element 206 are scaled ramp transistors 210, 212, and 214, each having a gate controlled by ramp control circuit 216 for selectively coupling the gates of transistors 202 and 208 to VSS. Although three transistors are shown, it should be understood that there can be any number of ramp transistors without straying from the intended scope of the present invention.

The transistors 210, 212, and 214 serve as parallel controlled resistance elements, which collectively function as a single controlled resistance element. Therefore, resistor 204 and the parallel controlled resistance elements are arranged in a voltage divider configuration for controlling input transistor 208. By controlling the gates of the transistors 210, 212 and 214 by way of ramp control circuit 216, the combined resistive value of the transistors 210, 212 and 214 can be changed, thereby changing the voltage on the gate of input transistor 208. It is noted that transistors are turned on by driving their gate terminals with an active signal, whereas they are turned off by driving their gate terminals with an inactive signal. An active signal is one that has a voltage level sufficient for turning on the transistor. As the resistive value rises, then input transistor 208 will be progressively turned on so as to feed the mixer element 102 with more and more current. This effectively controls the gain from V₁ to V₂. It should therefore be readily apparent that timing the gate control and selectively turning on each transistor 210, 212, and 214 will therefore provide a controlled ramping of the signal to the mixer element 102. Still further, each ramp transistor 210, 212 and 214 can be scaled in size. For example, ramp transistor 210 is sized to have a width-to-length (W/L) ratio of W1/L1. Then transistor 212 can have a size of W2/L2 and transistor 214 can have a size of W3/L3. In accordance with the present invention, each ramp transistor 210, 212 and 214 is sized differently from the other in a predetermined pattern. By example, there can be a scaling factor of two for each successive ramp transistor. Using the present example, W2/L2=2W1/L2. The length dimension of the ramp transistors can remain constant, such that L1=L2=L3.

In operation of the present invention, it is assumed that all ramp transistors 210, 212, and 214 are turned on to maintain the gate of the input transistor 208 as grounded when no signal transmission is occurring. When signal transmission commences and signal IN is received by V-I converter 200, The ramp control circuit 216 will turn off the first ramp transistor 210, followed by the next transistor 212 and so forth, until all ramp transistors 210, 212, and 214 are turned off. It should be noted that each ramp transistor 210, 212 and 214 is operated in the linear region and controlled to provide a logarithmic function with linear input control voltage, thereby providing a linear ramping profile of the input signal to the mixer 102. This logarithmic function correlates to the step size in decibels (dB) where the total attenuation from V₁ to V₂ is the sum of each dB step. The step size in dB from ramp transistors 210 to 212 is shown by Equation 1, using the example embodiment of FIG. 3.

20*log ((W2/L2)/(W1/L1)) Eq. 1

The step size in dB from ramp transistors 212 to 214 is shown by Equation 2.

20*log ((W3/L3)/(W2/L2)) Eq. 2

The total attenuation from V₁ to V₂ where three transistors are used is shown by Equation 3.

(20*log ((W2/L2)/(W1/L1)))+(20*log ((W3/L3)/(W2/L2))) Eq. 3

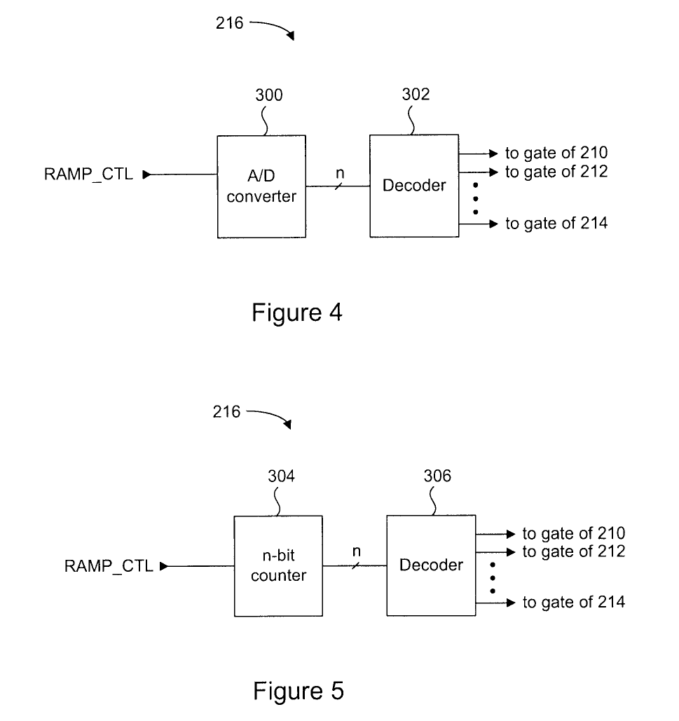

The ramp control circuit 216 may be driven by either an analog or digital ramp control signal, RAMP_CTL. In response to RAMP_CTL, ramp control circuit 216 will generate the signals for turning on or off ramp transistors 212 to 214. FIG. 4 is a block diagram of an implementation embodiment of ramp control circuit 216 when the ramp control signal is analog, whereas FIG. 5 is a block diagram of an implementation embodiment of the ramp control circuit 216 when the ramp control signal is digital.

In the instance whereby ramp control circuit 216 receives an analog control signal, the ramp control circuit 216 will include an analog to digital (A/D) converter 300 and a digital decoder 302 as shown in FIG. 4. It should be understood that the A/D converter 300 may be of any particular type. The analog signal RAMP_CTL, can be a voltage for example, can range between a low voltage level and a high voltage level. In one embodiment, RAMP_CTL may be initially at the low voltage level and is gradually ramped up to the high voltage level. Alternatively, RAMP_CTL may be initially at the high voltage level and then gradually ramped down to the low voltage level. In either scenario, the A/D converter 300 receives the analog control voltage and will output an n-bit digital signal where n is an integer selected for the desired resolution of A/D converter 300.

For each sampled voltage level of RAMP_CTL, the resulting n-bit digital signal provided by A/D converter 300 is subsequently decoded by a digital decoder 302. Digital decoder 302 will having logic decoding circuits configured for turning off at least one of the ramp transistors 210, 212 and 108 in response to the bit pattern of the n-bit digital signal. Therefore, as RAMP_CTL is ramped low to high (or high to low), different n-bit digital signals are generated synchronously with a sampling clock (not shown). Digital decoder 302 will successively turn off and keep turned off, each of the ramp transistors. In the specific embodiment of FIG. 3 for example, ramp transistors 210, 212 and 214 will be turned off in this ordered sequence. Digital decoding to achieve this desired result is well known in the art, and details of its implementation will not be discussed. When the transmission operation is completed, RAMP_CTL can be reset and all ramp transistors 210, 212 and 214 are turned on.

In an alternate example, if n=3 A/D converter 300 will provide a 3-bit output corresponding to a sampled voltage level of the input, then the decoder would be configured to provide 2ⁿ=2³=8 output signals. As suggested above, it should therefore be readily apparent that each output signal from the digital decoder 302 controls the gate of one power ramping transistor, for a total of 8 ramping transistors. In this analog technique, the A/D converter 300 would sample at a predetermined frequency based on a clock signal and such frequency would preferably be faster than the system clock. The rate at which the digital decoder 302 changes its output depends upon the frequency at which the A/D converter 300 samples the analog voltage.

In the instance whereby ramp control circuit 216 receives a digital control signal, RAMP_CTL can be a digital clock signal (CLK) used to feed an n-bit counter 304 as shown in FIG. 5. In this embodiment, n is an integer selected for the number of ramp transistors to be controlled, for example 2ⁿ ramp transistors. The counter 304 will increment the n-bit output sequence on each rising or falling edge of the oscillating clock signal (RAMP_CTL). Accordingly, the n-bit output sequence will gradually increase in value with each counted clock edge. As before, a digital decoder 306 receives the n-bit output sequence and decodes it to turn off the required ramping transistors as the binary value of the counter increases. The rate at which the digital decoder 306 changes its output depends upon the frequency of RAMP_CTL.

For both the analog and digital control signal techniques as shown in FIG. 4 and FIG. 5, there is minimum overlap between transistors turning off. That is to say, the timing is set so that each transistor 210, 212, and 214 is sequentially turned off which is easily accomplished by way of the digital decoder 306. Both the embodiments shown in FIGS. 4 and 5 provide digital outputs for controlling ramp transistors 210, 212, and 214. However, analog control over the gate voltages of ramp transistors 210, 212, and 214 can be used to control the rate of power increase of the input signal provided to mixer 102 of FIG. 3.

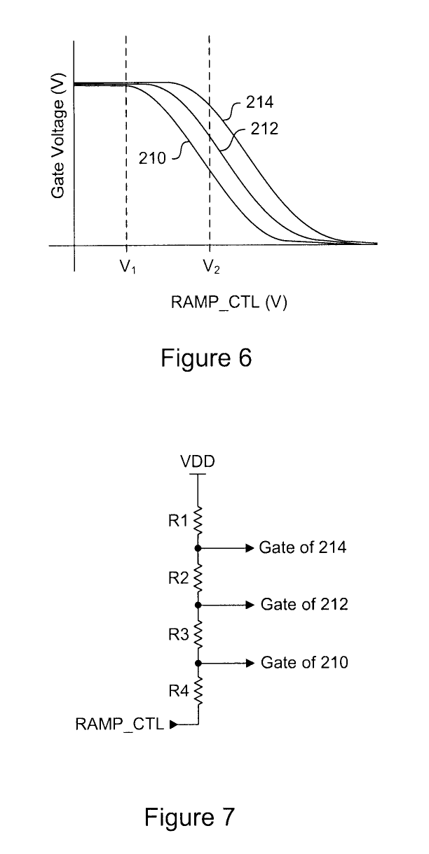

FIG. 6 is an example plot of the gate voltages of ramp transistors 210, 212, and 214 versus the analog ramp control voltage RAMP_CTL. This example plot shows that the gate voltage applied to ramp transistors 210, 212, and 214 are different from each other as RAMP_CTL increases in magnitude. This is an example of overlap between transistors turning off, meaning that at least two transistors are transitioning to the off state at the same time, but at different rates. As shown in FIG. 6, when RAMP_CTL is substantially zero volts, the gate voltages applied to ramp transistors 210, 212, and 214 are at substantially maximum levels. As RAMP_CTL increases, the gate voltage of transistor 210 is the first to decrease at RAMP_CTL =V1, followed by the gate voltages of transistors 212 and 214. As can be seen at RAMP_CTL =V2, all three transistors are still on. When RAMP_CTL reaches a predetermined maximum level, all ramp transistors will be turned off. Such type of ramp control can be implemented with different circuit techniques that are known in the art.

An example circuit embodiment for providing analog outputs for controlling ramp transistors 210, 212, and 214 is shown in FIG. 7. The ramp control circuit of FIG. 7 consists of a resistor network, or a voltage divider consisting of series connected resistor elements R1, R2, R3 and R4 connected between the voltage supply and RAMP_CTL. The common node of R1 and R2 is connected to the gate of transistor 214, the common node of R2 and R3 is connected to the gate of transistor 212, and the common node of R3 and R4 is connected to the gate of transistor 210. These common nodes can be referred to as voltage taps. In this configuration, as RAMP_CTL increases from VSS to some predetermined maximum level, the gate voltages will progressively decrease. The values of resistor elements R1, R2, R3 and R4 can be selected to obtain the voltage curves similar to those shown in FIG. 6.

Those skilled in the art will understand that the polarity of the voltage divider of FIG. 7 can be reversed, such that R1 receives the analog RAMP_CTL voltage, while R4 is connected to VSS. Hence the ramp transistors are all turned on by keeping RAMP_CTL at a high voltage level such as VDD, and then reducing RAMP_CTL to gradually turn off each of the ramp transistors. Accordingly, the gate control curves would be inverted relative to those shown in FIG. 6.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A transmit circuit for a wireless transceiver, said transmit circuit comprising:
an antenna for wirelessly transmitting a data signal;
a mixer coupled to the antenna for providing the data signal in response to a preconditioned data signal; and
a power ramping circuit having an input transistor for providing the preconditioned data signal in response to an input data signal, the power ramping circuit having a controllable resistance means for ramping the input data signal from a minimum voltage level to a maximum voltage level by decreasing a resistance of said resistance means.

2. The transmit path as claimed in claim 1, wherein the power ramping circuit includes
a voltage to current converter for providing a current corresponding to a base-band signal, and
a current mirror circuit having an input terminal for receiving the current and the input transistor having an output terminal for providing the preconditioned data signal, the controllable resistance means being coupled between the input transistor gate terminal and a voltage supply.

3. The transmit path as claimed in claim 2, wherein the current mirror circuit includes a filter connected in parallel to the controllable resistance means.

4. The transmit path as claimed in claim 3, wherein the filter is a first order filter including a resistor and a capacitor, the resistor and the controllable resistance means forming a voltage divider.

5. The transmit path as claimed in claim 1, wherein the controllable resistance means includes a plurality of parallel connected transistors.

6. The transmit path as claimed in claim 5, wherein said plurality of parallel connected transistors each include a gate terminal coupled to a ramp control circuit, said ramp control circuit sequentially turning off each one of said plurality of parallel connected transistors for ramping the input data signal from the minimum voltage level to the maximum voltage level.

7. The transmit path as claimed in claim 6, wherein said ramp control circuit includes
an analog to digital (A/D) converter for providing a digital output corresponding to an analog control signal, and
a digital decoder for selectively turning off each one of said plurality of parallel connected transistors in response to the digital output from the A/D converter.

8. The transmit path as claimed in claim 6, wherein said ramp control circuit includes
a counter for providing a digital output corresponding to counted edges of an oscillating signal, and
a digital decoder for selectively turning off each one of said plurality of parallel connected transistors in response to the digital output from the counter.

9. The transmit path as claimed in claim 5, wherein said plurality of parallel connected transistors each include a gate terminal coupled to a ramp control circuit, said ramp control circuit including a voltage divider circuit connected between a voltage supply and an analog control signal, the voltage divider circuit having voltage taps each coupled to each one of the plurality of parallel connected transistors.

10. A power ramping circuit for a wireless transmit circuit, comprising:
a voltage to current converter for providing an input current corresponding to a base-band voltage signal;
a current mirror for providing a data signal having a current with a maximum magnitude corresponding to the input current; and,
a plurality of controlled resistance elements coupled in parallel to the current mirror for ramping the current of the data signal from a minimum magnitude to the maximum magnitude as each of the controlled resistance elements are turned off.

11. The power ramping circuit as claimed in claim 10, wherein the current mirror includes
a diode connected transistor coupled between the voltage to current converter and a voltage supply for receiving the input current, and,
an input transistor arranged in a current mirror configuration with the diode connected transistor, the input transistor having a drain terminal for providing the data signal and a source terminal coupled to the voltage supply, the plurality of controlled resistance elements being coupled between the voltage supply and a gate terminal of the input transistor.

12. The power ramping circuit as claimed in claim 11, wherein the current mirror includes a first order filter having
a resistor connected between the gate terminal of the input transistor and the diode connected transistor, and
a capacitor coupled between the gate terminal of the input transistor and the voltage supply.

13. The power ramping circuit as claimed in claim 10, wherein said plurality of controlled resistance elements include a plurality of parallel connected transistors.

14. The transmit path as claimed in claim 13, wherein all of the plurality of parallel connected transistors are sized differently from each other.

15. The transmit path as claimed in claim 14, wherein each of the plurality of parallel connected transistors are sized to have different W/L dimensions, where W is a width of each of the plurality of parallel connected transistors and L is a length of each of the plurality of parallel connected transistors.

16. The transmit path as claimed in claim 15, wherein the plurality of parallel connected transistors are turned off in order of increasing size.

17. The power ramping circuit as claimed in claim 13, wherein said plurality of parallel connected transistors each include a gate terminal coupled to a corresponding gate control signal of a ramp control circuit for sequentially turning off each one of said plurality of parallel connected transistors.

18. The power ramping circuit as claimed in claim 17, wherein said ramp control circuit includes
an analog to digital (A/D) converter for providing a digital output corresponding to an analog control signal, and
a digital decoder for selectively turning off each one of said plurality of parallel connected transistors in response to the digital output from the A/D converter.

19. The power ramping circuit as claimed in claim 17, wherein said ramp control circuit includes
a counter for providing a digital output corresponding to counted edges of an oscillating signal, and
a digital decoder for selectively turning off each one of said plurality of parallel connected transistors in response to the digital output from the counter.

20. A method of ramping a signal within a wireless transceiver, said method comprising:
applying a voltage corresponding to a base band signal to an input transistor;
discharging the voltage with parallel connected transistors to minimize a current corresponding to the base band signal; and
sequentially turning off each of the parallel connected transistors for increasing a magnitude of the current provided by the input transistor.

21. The method as claimed in claim 20, wherein said step of discharging includes turning on all of the parallel connected transistors.

22. The method as claimed in claim 21, wherein the step of sequentially turning off includes
receiving a ramp control signal,
converting the ramp control signal into a digital output, and
decoding the digital output to turn off at least one of the parallel connected transistors.

23. The method as claimed in claim 22, wherein the ramp control signal is a ramped analog voltage level and the step of converting includes executing analog to digital conversion to provide the digital output corresponding to the analog voltage level at a predetermined frequency.

24. The method as claimed in claim 22, wherein the ramp control signal is an oscillating clock signal and the step of converting includes counting active edges of the oscillating clock signal with a counter to provide the digital output corresponding a value of the counter.

25. The method as claimed in claim 21, wherein the step of sequentially turning off includes
receiving an analog ramp control signal, and,
turning off at least two of the parallel connected transistors at different rates and at substantially the same time in response to the ramp control signal.
